(19) United States
(12) Patent Application Publication
(10) Pub. No.: US 2013/0325507 A1
(43) Pub. Date: Dec. 5, 2013

(54) MEDICAL INFORMATION DATA MANAGEMENT SYSTEM

(71) Applicant: KONICA MINOLTA, INC., Tokyo (JP)

(72) Inventor: Naokazu KUWAYAMA, Tokyo (JP)

(21) Appl. No.: 13/905,005

(22) Filed: May 29, 2013

(30) Foreign Application Priority Data
Jun. 4, 2012 (JP) 2012-126651

(51) Int. Cl. G06F 19/00

(52) U.S. Cl. CPC G06F 19/322
USPC 705/3

(57) ABSTRACT

Disclosed is a medical information data management system for managing a plurality of medical information data sets generated at a plurality of medical facilities including a specifying unit, which specifies arbitrary management units, each of which including one or a plurality of medical information data sets, with respect to the plurality of medical information data sets, an ID issuing unit which issues cooperation management IDs respectively to the specified management units, and a storage unit which stores the issued cooperation management IDs and the medical information data sets. In the storage unit, each cooperation management ID is associated with medical information data sets that belong to a management unit corresponding to the cooperation management ID.

### BACKGROUND OF THE INVENTION

1. Field of the Invention

The present invention relates to a medical information data management system.

2. Description of Related Art

In recent years, as medical technology has diversified, cooperative medical services in community where a hospital with specialized function and a plurality of medical facilities such as clinics share medical information data and perform examinations and treatments on patients in cooperation with each other have become widely utilized. Especially, cases where specialized operations such as image interpretations are to be outsources are increasing.

For example, there is suggested a technique for searching medical information data of a patient in a system where a medical information data sharing server is provided with a data sharing DB for accumulating medical information data sets owned by a plurality of medical facilities by determining whether the uploaded medical information data set and the past medical information data sets a patient are already registered and managing the medical information data sets by associating the data sets with the management IDs respectively assigned to patients (see JP 2008-204378).

However, in the above conventional technique, because patient information is used as the key for sharing medical information data sets, medical information data sets cannot be shared in units of medical treatments or in units of examinations. Therefore, every time the desired medical information data sets are to be viewed, patient information needs to be input as the search key. Thus, searching is troublesome.

Moreover, although patient information, examination information and the like are attached to image data which is in compliance with DICOM (Digital Imaging and Communications in Medicine) standard, in many cases, image diagnosis results, image analysis results and the like are formed in data format (for example, PDF (Portable Document Format), PNG (Portable Network Graphics), Excel, Word and the like) to which patient information and examination information are not attached. An electronic method for efficiently and integrally managing such medical information data other than DICOM data has been desired and anticipated.

### SUMMARY OF THE INVENTION

In view of the above problem in the convention technique, an object of the present invention is to efficiently manage medical information data sets.

In order to solve the above problem, according to one aspect of the present invention, a medical information data management system for managing a plurality of medical information data sets generated at a plurality of medical facilities includes a specifying unit which specifies arbitrary management units, each of which including one or a plurality of medical information data sets, with respect to the plurality of medical information data sets, an ID issuing unit which issues cooperation management IDs respectively to the specified management units, and a storage unit which stores the issued cooperation management IDs and the medical information data sets, each cooperation management ID being associated with medical information data sets that belong to a management unit corresponding to the cooperation management ID.

According to the present invention, because the medical information data sets are managed in arbitrary management units, the medical information data sets can be managed efficiently.

Preferably, the medical information data management system further includes a second storage unit which stores the cooperation management IDs and viewing right information indicating viewing rights of the medical information data sets, each cooperation management ID being associated with viewing right information indicating viewing rights of medical information data sets that belong to a management unit corresponding to the cooperation management ID, and a permission unit which permits viewing of the medical information data sets stored in the storage unit in management units on a basis of the viewing right information stored in the second storage unit.

Preferably, the medical information data management system further includes a third storage unit which stores the cooperation management IDs and patient information, examination information or keywords relating to the medical information data sets, each cooperation management ID being associated with patient information, examination information or a keyword relating to medical information data sets that being to a management unit corresponding to the cooperation management ID, and a search unit which searches for medical information data sets stored in the storage unit in management units on a basis of the patient information, the examination information or the keywords stored in the third storage unit.

### BRIEF DESCRIPTION OF THE DRAWINGS

The present invention will become more fully understood from the detailed description given hereinbelow and the appended drawings which are given by way of illustration only, and thus are not intended as a definition of the limits of the present invention, and wherein:

FIG. 1 is a system configuration diagram of a cooperative medical system;

FIG. 2 is a block diagram showing a functional configuration of a data management server;

FIG. 3 is a data configuration example of a cooperation management information table, a contents information table, a patient information table, an examination information table, an image information table, a cooperation history information table, a viewing right information table and a cooperator information table;

FIG. 4 is a block diagram showing a functional configuration of a terminal device;

FIG. 5 is a ladder chart showing a new registration process which is performed by a terminal device and the data management server;

FIG. 6 is a flowchart showing a cooperation management ID issuing process which is performed by the data management server;

FIG. 7 is a flowchart showing the cooperation management ID issuing process which is performed by the data management server;

FIG. 8 is a ladder chart showing an additional sending or replying process which is performed by a terminal device and the data management server;

FIG. 9 is a ladder chart showing a deletion process which is performed by a terminal device and the data management server;

FIG. 10 is a ladder chart showing a can/cannot be viewed determination process which is performed by a terminal device and the data management server;

FIG. 11 is an example of a cooperation list screen to be displayed at a terminal device; and

FIG. 12 is a ladder chart showing a search process which is performed by a terminal device and the data management server.

### DESCRIPTION OF THE PREFERRED EMBODIMENTS

### [Configuration of Cooperative Medical System]

Hereinafter, an embodiment of a medical information data management system according to the present invention will be described with reference to the drawings.

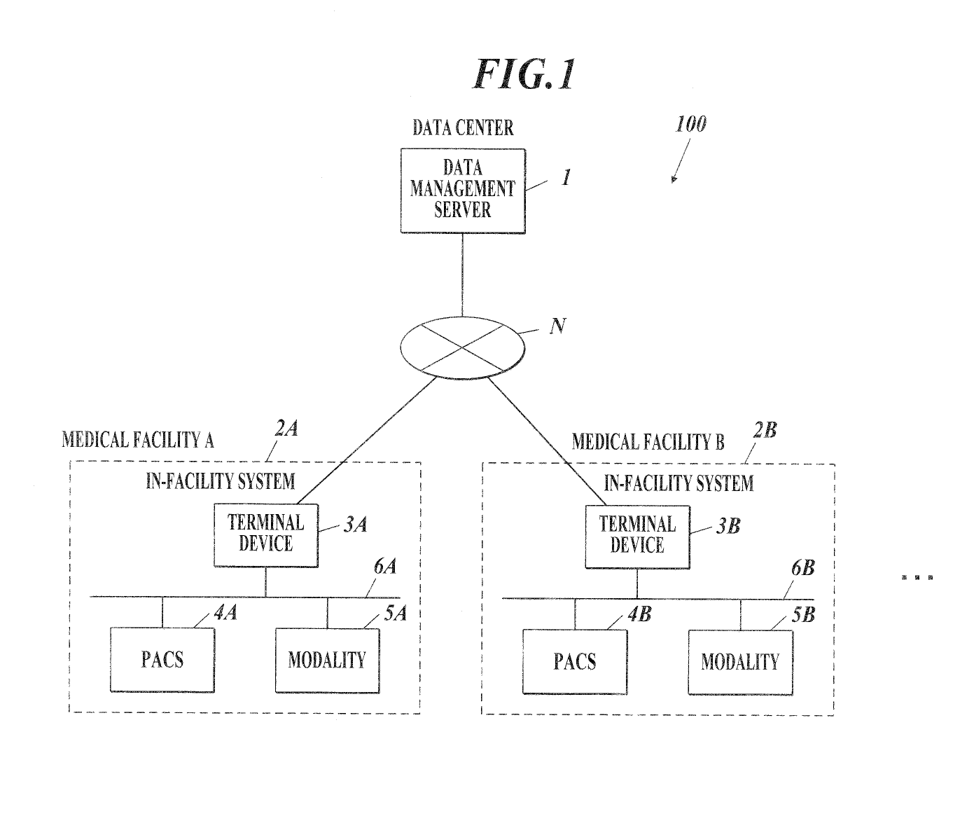

FIG. 1 shows a system configuration of the cooperative medical system 100 as a medical information data management system.

As shown in FIG. 1, the cooperative medical system 100 includes a data management server 1 which is set at the data center of a community, an in-facility system 2A which is set at a medical facility A, an in-facility system 2B which is set at a medical facility B and such like. The data management server 1, the in-facility system 2A, the in-facility system 2B and the like are connected to each other through a communication network N such as the internet so that data communication can be performed with each other.

Here, the number of the in-facility systems 2A, 2B . . . which constitute the cooperative medical system 100 and the number of devices in each of the in-facility systems 2A, 2B . . . are not specifically limited.

The data management server 1 accumulates and manages medical information data sets generated at medical facilities. Further, the data management server 1 provides cooperative medical service between medical facilities. The data management server 1 receives requests from the in-facility systems 2A, 2B . . . for carrying out examinations and image interpretations in other in-facility systems and manages data of the examination results and image interpretation results.

The in-facility system A includes a terminal device 3A, a PACS (Picture Archiving and Communication System) 4A, a modality 5A and the like which are connected to each other through an in-facility network 6A such as a LAN (Local Area Network) so that data communication can be performed with each other. The terminal device 3A is connected with the data management server 1 through the communication network N so as to perform data communication therebetween.

The in-facility system 2B includes a terminal, device 3B, a PACS 4B, a modality 5B and the like which are connected to each other through an in-facility network 6B such as a LAN so that data communication can be performed with each other.

The terminal device 3A is a computer used by a healthcare professional at the clinic A to perform medical cooperation with a healthcare professional at another medical facility. The terminal device 3A is used to access the data management server 1 through the communication network N, to send medical information data sets to the data management server 1 and to view the medical information data sets stored in the data management server 1.

Similarly, the terminal device 3B is a computer used by a healthcare professional at the clinic B to perform medical cooperation with a healthcare professional at another medical facility. The terminal device 3B is used to access the data management server 1 through the communication network N, to send medical information data sets to the data management server 1 and to view the medical information data sets stored in the data management server 1.

The above description applies for terminal devices which are provided at medical facilities other than the medical facilities A and B.

Each of the PACSs 4A, 4B . . . is a computer including a control unit, a RAN (Random Access Memory), a communication unit, an operating unit, a display unit, a storage unit and the like. The PACSs 4A, 4B . . . are in-facility servers which mainly store the medical image data and the like generated by in-facility modalities 5A, 5B . . . in their storage units by associating the medical image data and the like with patient information.

The modalities 5A, 5B . . . pick up images of human body and generate digital data of the picked up images (medical images). For example, CR (Computed Radiography), FPD (Flat Panel Detector), CT (Computed Tomography), MRI (Magnetic Resonance Imaging), a reading device exclusive to cassette, a film digitizer and the like can be applied as the modalities.

### [Configuration of Data Management Server]

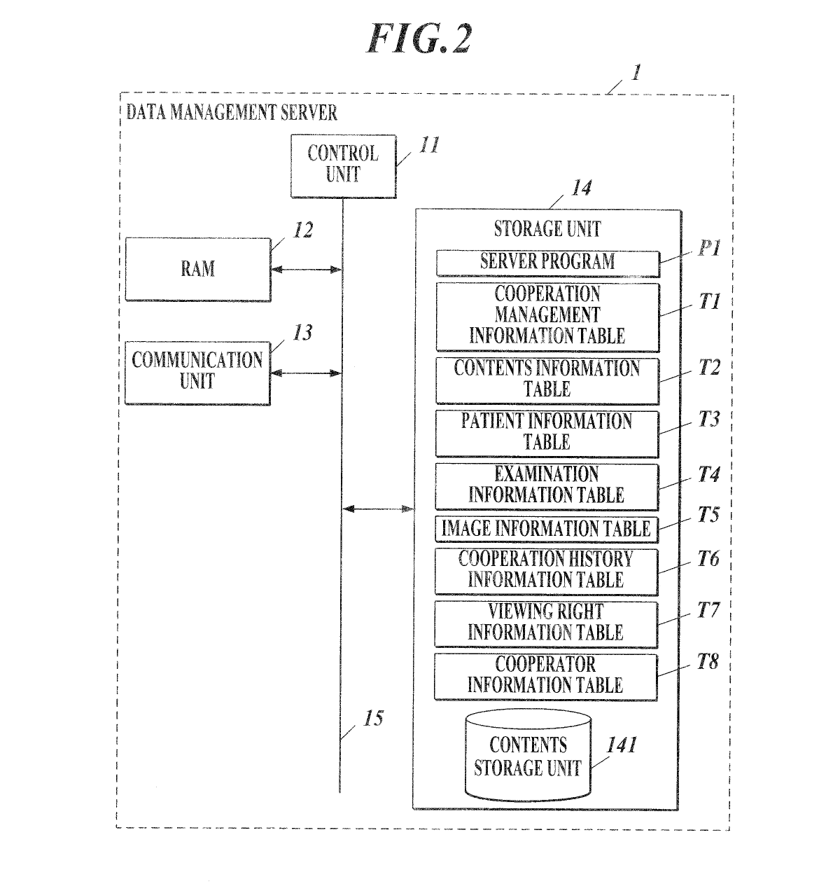

FIG. 2 shows a functional configuration of the data management server 1.

As shown in FIG. 2, the data management server 1 includes a control unit 11, a RAM 12, a communication unit 13, a storage unit 14 and the like and they are connected to each other through a bus 15.

The control unit 11 includes a CPU (Central Processing Unit) and the like and integrally controls the processing operations of the parts in the data management server 1. The control unit 11 reads various types of programs stored in the storage unit 14 and expands the programs in the RAM 12 to execute various types of processes in cooperation with the programs.

In the RAM 12, there are formed work area to temporarily store various types of programs which are read out from the storage unit 14 in the various types of processes which are executed and controlled by the control unit 11, and data and parameters which are input or output in the various types of processes which are executed and controlled by the control unit 11.

The communication unit 13 includes a network interface and the like and performs sending and receiving of data with an external device which is connected via the communication network N. For example, the communication unit 13 receives medical information data sets sent from the terminal devices 3A, 3B . . . and sends medical information data sets to the terminal devices 3A, 3B . . . .

The storage unit 14 includes a HDD (Hard Disk Drive), a semiconductor non-volatile memory or the like. In the storage unit 14, parameters and data required for executing the various types of programs are store in addition to the various types of programs which are to be executed by the control unit 11. In particular, a server program P1, a cooperation management information table T1, a contents information table T2, a patient information table T3, an examination information table T4, an image information table T5, a cooperation history information table T6, a viewing right information table T7 and a cooperator information table T8 are stored in the storage unit 14. Further, the storage unit 14 includes a contents storage unit 141.

The server program P1 is a program for executing the data management process, the process for providing cooperative medical service and the like in the data management server 1.

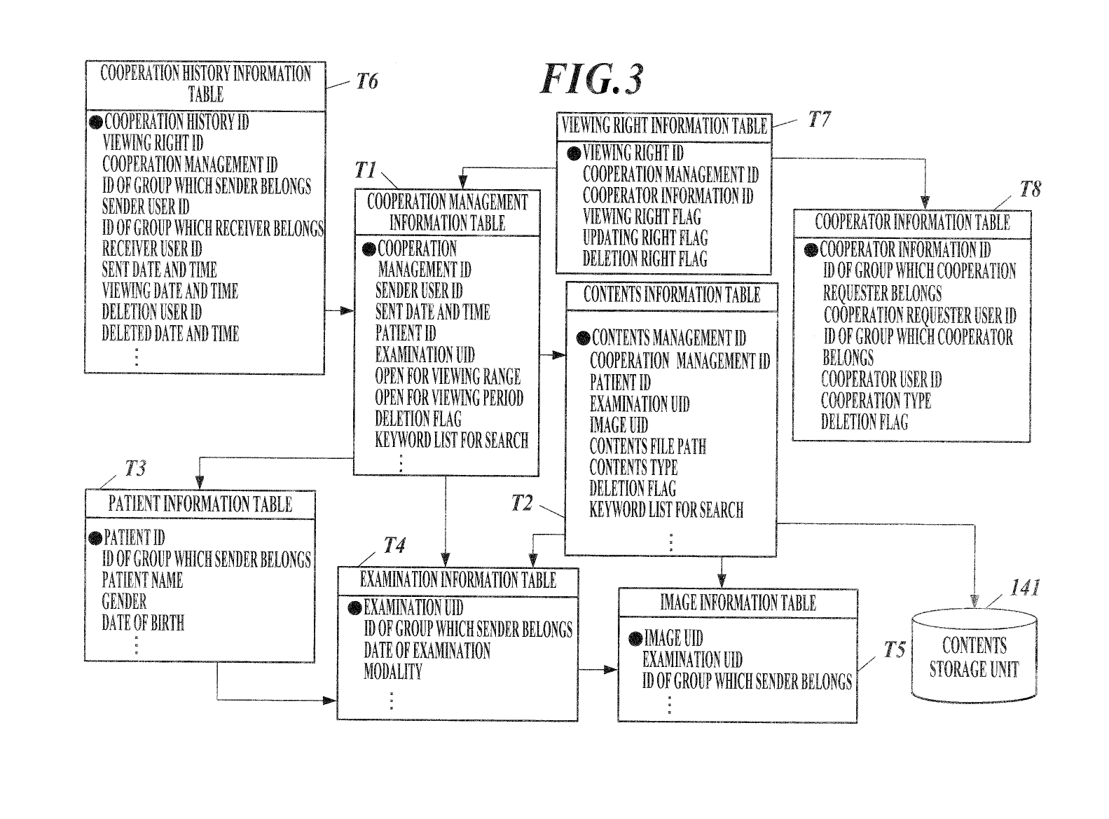

FIG. 3 shows a data configuration example of the cooperation management information table T1, the contents information table T2, the patient information table T3, the examination information table T4, the image information table T5, the cooperation history information table T6, the viewing right information table T7 and the cooperator information table T8.

In the cooperation management information table T1, information is stored in management units where one or a plurality of medical information data sets are grouped as one unit. In the cooperation management information table T1, “sender user ID”, “sent date and time”, “patient ID”, “examination ID”, “open for viewing range”, “open for viewing period”, “deletion flag”, “keyword list for search” and the like are made to be associated with “cooperation management ID”.

The “cooperation management ID” is identification information assigned to each management unit.

The “sender user ID” is identification information for identifying the user who is the sender of a medical information data set.

The “sent date and time” is the date and time when a medical information data set was sent.

The “patient ID” is identification information for identifying a patient.

The “examination UID” is identification information for identifying an examination. For example, if data is in DICOM format, a value of “examination instance UID” is used.

The “open for viewing range” indicates what extent a medical information data set that belongs to the management unit corresponding to the associated “cooperation management ID” is open for viewing. As an example of “open for viewing range”, the following meanings are assigned to the numeral values 0 to 5.

0: closed (only the sender user can view)

1: fully open (anyone can view)

2: opened to inside persons (only those users who belong to the same groups as the sender user can view)

3: opened to cooperators (only those receiver users who are specified by the sender user and the sender user can view)

4: opened to inside persons and cooperators (combination of the above 2 and 3)

5: temporarily opened to inside persons and cooperators (the open for viewing range is according to “4” during the open for viewing period and is according to “2” after the open for viewing period)

The “open for viewing period” indicates a time period during which a medical information data set that belongs to the management unit corresponding to the associated “cooperation management ID” is open for viewing.

The “deletion flag” is a flag which indicates whether each record in the cooperation management information table T1 is to be deleted. The flag is “ON” when a record is to be deleted and the flag is “OFF” when a record is not to be deleted.

The “keyword list for search” is a list of keywords for searching a medical information data set that belongs to the management unit corresponding to the associated “cooperation management ID”.

In the contents information table T2, information on each medical information data set is stored. In the contents information table T2, “cooperation management ID”, “patient ID”, “examination UID”, “image UID”, “contents file path”, “contents type”, “deletion flag”, “keyword list for search” and the like are made to be associated with “contents management ID”.

The “contents management ID” is identification information assigned to each medical information data set (contents).

The “image UID” is identification information, for identifying an image. For example, if data is in DICOM format, a value of “SOP instance UID” is used.

The “contents file path” is information indicating the storage location of a file of medical information data set (contents) in the contents storage unit 141.

The “contents type” is information indicating the type of a medical information data set (contents) such as movie, audio sound or the like.

The “deletion flag” is a flag indicating whether each record in the contents information table T2 is to be deleted. The flag is “ON” when a record is to be deleted and the flag is “OFF” when a record is not, to be deleted.

The “keyword list for search” is a list of keywords for searching the medical information data set corresponding to the associated “contents management ID”.

In the patient information table T3, information relating to patients (patient information) is stored. In the patient information table T3, “ID of group which sender belongs”, “patient name”, “gender”, “date of birth” and the like are made to be associated with “patient ID”.

The “ID of group which sender belongs” is identification information for identifying the group (s) which the user who is the sender of the corresponding medical information data set belongs to.

The “patient name”, “gender” and “date of birth” are the name, gender and date of birth of patients, respectively.

In the examination information table T4, information relating to examinations (examination information) is stored. In the examination information table T4, “ID of group which sender belongs”, “date of examination”, “modality” and the like are made to be associated with “examination UID”.

The “date of examination” and “modality” are the date when examinations took place and the modality by which the examinations were performed, respectively.

In the image information table T5, information relating to examination images is stored. In the image information table T5, “examination DID”, “ID of group which sender belongs” and the like are made to be associated with “image UID”.

In the cooperation history information table T6, information used for managing the history such as new registration, viewing, update, deletion and the like in management units is stored. In the cooperation history information table T6, “viewing right ID”, “cooperation management ID”, “ID of group which sender belongs”, “sender user ID”, “ID of group which receiver belongs”, “receiver user ID”, “sent date and time”, “viewed date and time”, “deletion user ID”, “deleted date and time” and the like are made to be associated with “cooperation history ID”.

The “cooperation history ID” is identification information assigned to each change in medical information data such as new registration, viewing, update, deletion and the like with respect to the medical information data sets of each management unit

The “viewing right ID” is identification information assigned to information indicating the rights managed by the viewing right information table T7.

The “ID of group which receiver belongs” is identification information for identifying the group(s) the user who is the receiver of a medical information data set belongs to.

The “receiver user ID” is identification information for identifying the user who is the receiver of a medical information data set.

The “viewed date and time” is the date and time when a medical information data set was viewed by the receiver.

The “deletion user ID” is identification information for identifying the user who deleted a medical information dataset.

The “deletion date and time” is the date and time when a medical information data set was deleted.

In the viewing right information table T7, information indicating the rights is stored. In the viewing right information table T7, “cooperation management ID”, “cooperator information ID”, “viewing right flag”, “updating right ID flag” and “deletion right flag” are made to be associated with “viewing right ID”.

The “cooperator information ID” is identification information assigned to information which indicates the relation between a cooperation requester and a cooperator managed by the cooperator information table T8.

The “viewing right flag” is a flag that indicates whether the viewing right is given or canceled with respect to each record in the viewing right information table T7. The flag is “ON” if the viewing right is given and the flag is “OFF” if the viewing right is canceled.

The “updating right flag” is a flag which indicates the updating right with respect to each record in the viewing right information table T7. Any one can update the record if the updating right flag is “0”, only the user(s) who is(are) the receiver can update the record if the updating right flag is “1” and both the user who is the sender and the user(s) who is(are) the receiver can update the record if the updating right flag is “3”. Here, updating includes both additional sending or replying of a medical information data set and correcting/overwriting of a medical information data set.

The “deletion right flag” is a flag which indicates the right to delete each record in the viewing right information table T7. Any one can delete the record if the deletion right flag is “0”, only the user who is the sender can delete the record if the deletion right flag is “1”, only the user(s) who is (are) the receiver can deleted the record if the deletion right flag is “2” and both the user who is the sender and the user(s) who is (are) the receiver can delete the record if the deletion right flag is “3”.

In the cooperator information table T8, information indicating the relation between a cooperation requester and a cooperator is stored in advance. In the cooperator information table T8, “ID of group which cooperation requester belongs”, “cooperation requester user ID”, “ID of group which cooperator belongs”, “cooperator user ID”, “cooperation type” and “deletion flag” are made to be associated with “cooperator information ID”.

The “ID of group which cooperation, requester belongs” is identification information for identifying the group(s) to which the user who is the cooperation requester (who requests cooperation in cooperative medical service) belongs.

The “cooperation requester user ID” is identification information for identifying the user who is the cooperation requester.

The “ID of group which cooperator belongs” is identification information for identifying the group(s) to which the user(s ) who is (are) the cooperator (who receives the request in cooperative medical service) belongs.

The “cooperator user ID” is identification information for identifying the user(s) who is(are) the cooperator.

The “cooperation type” is information indicating whether the cooperation requester and the cooperator are individuals or groups. As for the “cooperative type”, one of “user vs. user”, “group vs user”, “user vs. group” and “group vs. group” is set.

The “deletion flag” is a flag which indicates whether each record is to be deleted in the cooperator information table T8. The flag is “ON” if a record is to be deleted and the flag is “OFF” if a record is not to be deleted.

In the contents storage unit 141, medical information data sets relevant, to the medical cooperation are stored. Medical information data is information generated in the process of medical treatments for each patient. As for medical information data, medical image data, examination data, digital medical record data, image interpretation report, pathological diagnosis report and the like are suggested, for example. Moreover, medical information data may be in various types of data formats such as PDF, PNG, Excel and Word other than image data which is formed with attachment information such as patient information and examination information attached in compliance with the DICOM format to a medical image obtained by picking up an image of a patient (hereinafter called DICOM data).

In compliance with the server program P1 stored in the storage unit 14, the control unit 11 assigns a cooperation management ID to each of the one or a plurality of medical information data sets sent from the terminal devices 3A, 3B . . . , the cooperation management ID being unique to each management unit and the same unique cooperation management ID being assigned to the medical information data sets that belong to the same management unit, and manages the medical information data sets that belong to the management unit corresponding to the same cooperation management ID as one cooperation data set. Here, cooperation data means one series of medical information data sets managed under the same cooperation management ID.

The control unit 11 issues a cooperation management ID to each of the management units specified in the terminal devices 3A, 3B . . . . That is, the control unit 11 functions as an ID issuing unit.

The control unit 11 stores the issued cooperation management IDs and the medical information data sets that belong to the respective management units corresponding to the issued cooperation management IDs in the storage unit 14 with association to each other. In particular, the control unit 11 stores the medical information data sets in the contents storage unit 141 and stores the “contents management ID”, “cooperation management ID” and “content file path” which are assigned to each medical information data set with association to each other in the contents information table T2. Thereby, a given cooperation management ID and the medical information data sets that belong to the management unit corresponding to the given cooperation management ID are made to be associated with each other.

The control unit 11 stores a given cooperation management ID and viewing right information indicating the viewing right of the medical information data sets that belong to the management unit corresponding to the given cooperation management ID in the storage unit 14 with association to each other. In particular, the control unit 11 stores “cooperation management ID”, “ID of group which receiver belongs” and “receiver user ID” with association to each other in the cooperation history information table T6, stores “cooperation management ID”, “cooperator information ID” and “viewing right flag” with association to each other in the viewing right information table T7 and stores “cooperation management ID” and “open for viewing range” with association to each other in the cooperation management information table T1. Thereby, a given cooperation management ID and the viewing right information with respect to the medical information data sets that belong to the management unit corresponding to the given cooperation management ID are made to be associated with each other.

On the basis of the viewing right information stored in the storage unit 14, the control unit 11 permits, in units of management, viewing of the medical information data sets stored in the storage unit 14. That is, the control unit 11 functions as a permission unit. In particular, the control unit 11 refers to the tables stored in the storage unit 14 to determine whether the relevant user has the viewing right to each management unit and permits viewing of the medical information data sets that belongs to the management unit the user has viewing right.

The control unit 11 stores a given cooperation management ID and the patient information, examination information and keywords relating to the medical information data sets that belong to the management unit corresponding to the given cooperation management ID in the storage unit 14 with association to each other. In particular, the control unit 11 stores “cooperation management ID”, “patient ID”, “examination UID” and “keyword list for search” by making them associated with each other in the cooperation management information table T1. Thereby, a given cooperation management ID and the patient information, examination information and keywords relating to the medical information data sets that belong to the management unit corresponding to the given cooperation management ID are made to be associated with each other.

On the basis of the patient information, examination information or keywords stored in the storage unit 14, the control unit 11 searches for medical information data sets in management units stored in the stored unit 14. That is, the control unit 11 functions as a search unit. In particular, the control unit 11 refers to the table stored in the storage unit 14 to extract the “cooperation management ID” associated with the patient information, examination information or a keyword which is input as a search key and provides the medical information data sets that belong to the management unit corresponding to the extracted “cooperation management ID”.

The control unit 11 mediates sending and receiving of medical information data sets between terminal devises set at two different medical facilities (cooperative medical service). As for the types of medical cooperation, for example, referrals of patients, examination requests, image interpretations, consultations are suggested. The control unit 11 stores the medical information data sets which are sent from one of the terminal devices being operated by two users between which a cooperation relation is established in the storage unit 14. Further, if obtaining of medical information data set is requested by the other of the terminal devices, the control unit 11 determines whether the user who operates the other of the terminal devices has the viewing right, and if the user has the viewing right, the control unit 11 reads out the requested medical information data set from the storage unit 14 and provides the other terminal device with the medical information data set.

### [Configuration of Terminal Device]

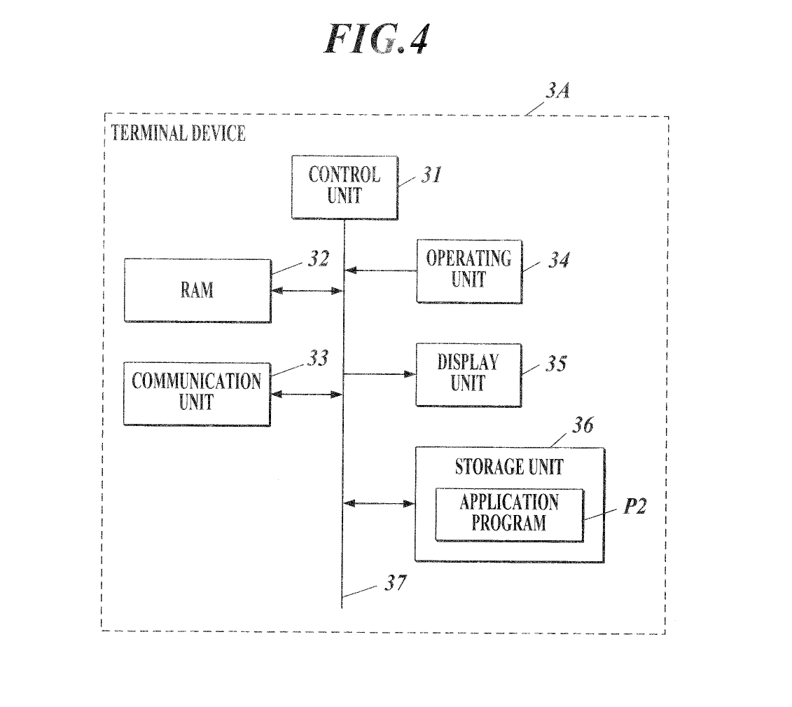

FIG. 4 shows a functional configuration of the terminal device 3A.

As shown in FIG. 4, the terminal device 3A includes a control unit 31, a RAM 32, a communication unit 33, an operating unit 34, a display unit 35, a storage unit 37 and the like, and they are connected through a bus 36 or the like.

The control unit 31 is configured of a CPU and the like and integrally controls the processing operation of each unit in the terminal device 3A. The control unit 31 reads out various types of programs stored in the storage unit 36 and expands the programs in the RAM 32, and the control unit 31 executes various types of processes in cooperation with the programs.

In the RAM 32, there are formed work areas to temporarily store various types of programs which are read out from the storage unit 36 in the various types of processes which are executed and controlled by the control unit 31, and data and parameters which are input, or output in the various types of processes which are executed and controlled by the control unit 31.

The communication unit 33 includes a network interface and the like and performs sending and receiving of data with an external device which is connected through the communication network N or the in-facility network 6A. For example, the communication unit 33 sends medical information data sets to the data management server 1 and receives medical information data sets from the data management server 1.

The operating unit 34 includes a key board having a cursor key, numerical input keys, various types of function keys and the like and a pointing device such as a mouse. The operating unit 34 outputs operation signals input by key operations performed on the key board and mouse operations to the control unit 31. For example, the operating unit 34 is used when a user who operates the terminal device 3A specifies an arbitrary management unit that includes one or a plurality of medical information data sets among a plurality of medical information data sets. That is, the operating unit 34 functions as a specifying unit.

The display unit 35 includes a monitor such as LCD (Liquid Crystal Display) and displays various types of screens according to instructions of display signals input from the control unit 31.

The storage unit 36 includes a HDD, a semiconductor non-volatile memory or the like. In the storage unit 36, parameters and data required for executing the various types of programs are store in addition to the various types of programs which are to be executed by the control unit 31. In particular, in the storage unit 36, the application program P2 and the like are stored.

The application program P2 is a program for executing the sending process of medical information data sets, the process for using the cooperative medical service and the like in the terminal device 3A.

The control unit 31 sends the medical information data sets specified by the operating unit 34 and the information indicating the management unit specified by the operating unit 34 to the data management server 1 via the communication unit 33.

The terminal device 3B and the like have configurations similar to that of the terminal device 3A, Therefore, FIG. 4 is also used for the terminal device 3B and the descriptions are omitted.

### [New Registration Process]

Next, operations according to the embodiment will be described.

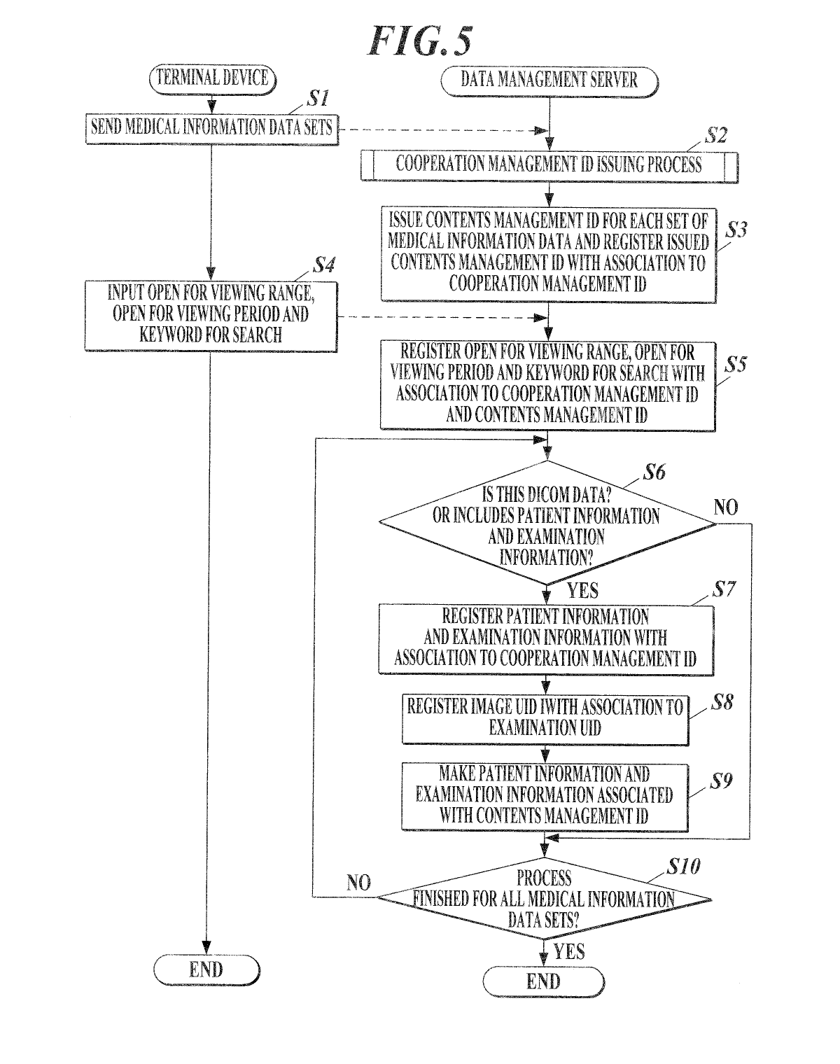

FIG. 5 is a ladder chart showing the new registration process performed by the terminal device 3A and the data management server 1. Here, the operation performed in the data management server 1 is executed by the control unit 11 and the server program P1 cooperating with each other, and the operation performed in the terminal device 3A is executed by the control unit 31 and the application program P2 cooperating with each other.

First, in the terminal device 3A, the control unit 31 sends one or a plurality of medical information data sets to the data management server 1 via the communication unit 33 on the basis of the operation performed on the operating unit 34 (step S1).

Here, the ID of group which sender belongs, the sender user ID, the ID of group which receiver belongs, the receiver user ID and the sent date and time of each medical information data set are also sent to the data management server 1 from the terminal device 3A.

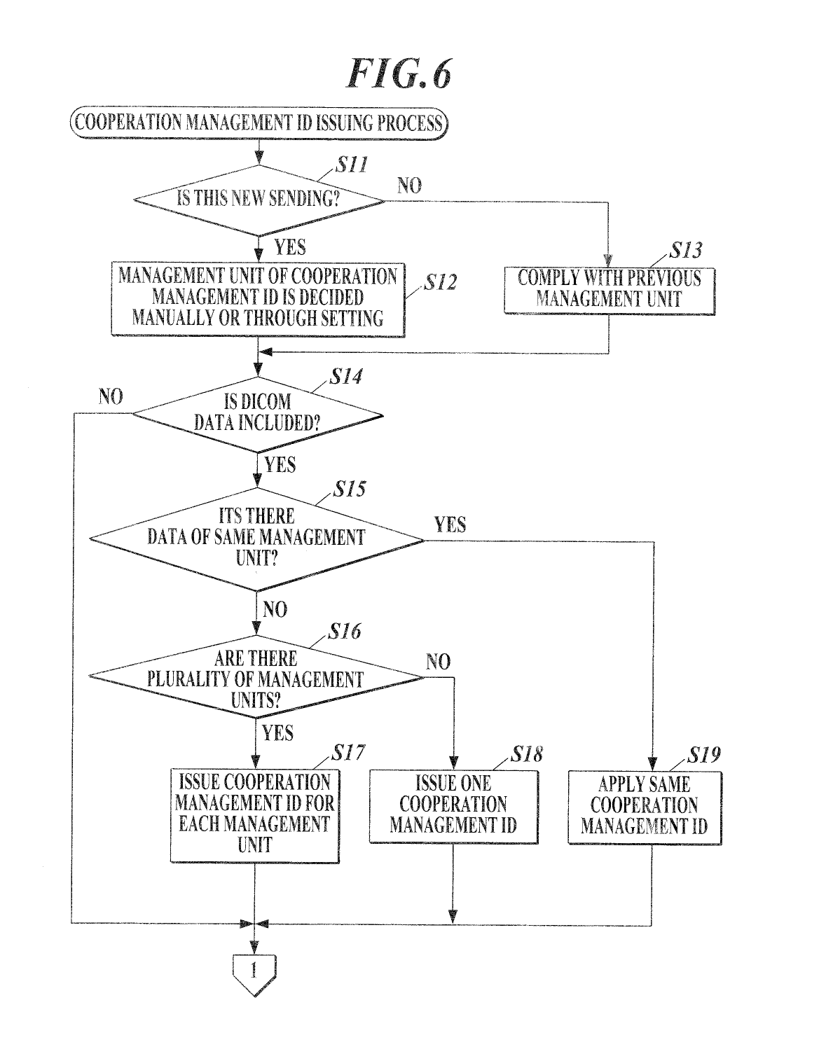

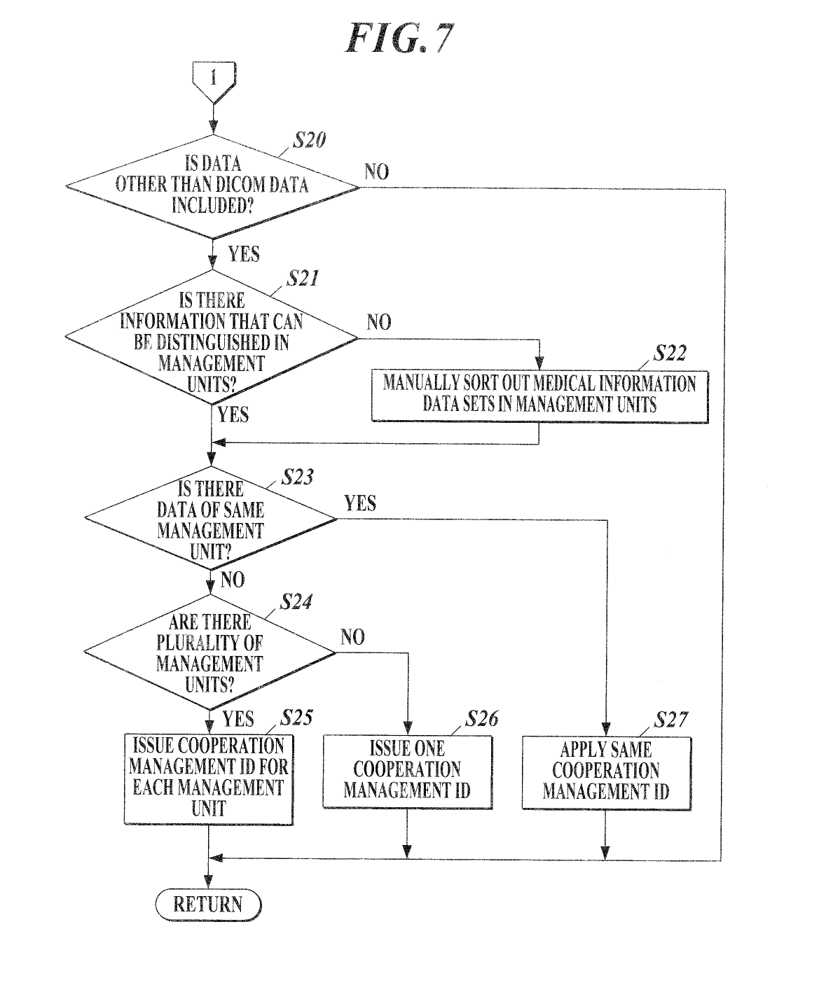

In the data management server 1, the medical information data sets and the like sent from the terminal device 3A are received by the communication unit 13 and the cooperation management ID issuing process (see FIGS. 6 and 7) is carried out by the control unit 11 (step S2). The cooperation management ID issuing process will be described in detail later.

Further, for each medical information data set which is received, the control unit 11 adds a new record to the cooperation management information table T1 in the storage unit 14 and stores the “sender user ID” and “sent date and time” received from the terminal device 3A in the cooperation management information table T1 by making them associated with the “cooperation management ID” issued in step S2. Here, in the cooperation management information table T1, the “deletion flag” of the new record is set to “OFF”.

Furthermore, for each medical information data set which is received, the control unit 11 adds a new record to the cooperation history information table T6 in the storage unit 14. In particular, the control unit 11 newly assigns “cooperation history ID” and stores the “cooperation management ID” issued in step S2, the “ID of group which sender belongs”, “sender user ID”, “ID of group which receiver belongs”, “receiver user ID” and “sent date and time” received from the terminal device 3A in the cooperation history information table T6 by making them associated with the newly assigned “cooperation history ID”.

Moreover, from the cooperator information table T8, the control unit 11 obtains the “cooperator information ID” which is associated with the combination of “ID of group which cooperation requester belongs”, “cooperation requester user ID”, “ID of group which cooperator belongs” and “cooperator user ID” corresponding to the combination of the “ID of group which sender belongs”, “sender user ID”, “ID of group which receiver belongs” and “receiver user ID” received from the terminal device 3A, and the control, unit 11 adds a new record to the viewing right information table T7 in the storage unit 14. In particular, the control unit 11 newly assigns “viewing right ID” and stores the “cooperation management ID” issued in step S2 and the “cooperator information ID” obtained from the cooperator information table T8 in the viewing right information table T7 by making them associated with the newly assigned “viewing right ID”. Here, in the viewing right information table T7, the “viewing right flag” of the new record is set to “ON”, Further, in the viewing right information table T7, predetermined values determined based on the setting information sent from the terminal device 3A are stored as the “updating right flag” and “deletion right flag” of the new record.

Furthermore, the control unit 11 adds “viewing right ID” (“viewing right ID” of the new record added to the viewing right information table T7) to the cooperation history information table T6 in the storage unit 14 with association to the “cooperation history ID”.

Next, the control unit 11 stores each medical information data set in the content storage unit 141 and issues “content management ID” to each medical information data set, and registers the issued “contents management ID” With association to the “cooperation management ID” (step S3). In particular, the control unit 11 adds a new record to the contents information table T2 for each medical information data set. Then, for each medical information data set, the control unit 11 newly assigns “contents management ID” and stores the “cooperation management ID”, “contents file path” and “contents type” in the contents information table T2 by making them associated with the newly assigned “contents management ID”. Here, in the contents information table T2, the “deletion flag” of each new record is set to “OFF”.

Next, in the terminal device 3A, the open for viewing range, open for viewing period, keywords for search are input by the operating unit 34 and the open for viewing range, open for viewing period and keywords for search are sent to the data management server 1 by the control unit 31 via the communication unit 33 (step S4). As for the keywords for search, keywords for search relating to management units and keywords for search relating to medical information data sets (contents) can be specified separately.

In the data management server 1, the communication unit 13 receives the open for viewing range, open for viewing period and keywords for search which are sent from the terminal device 3A and the control unit 11 registers the “open for viewing range”, “open for viewing period” and “keywords for search” with association to the “cooperation management ID” and “contents management ID” (step S5). In particular, the control unit 11 stores the “open for viewing range”, “open for viewing period” and the “keywords for search” relating to the management unit in the cooperation management information table T1 with association to the “cooperation management ID”, and the control unit 11 stores the “keywords for search” relating to the contents in the contents information table T2 with association to the “contents management ID”.

In a case where a medical information data set is DICOM data, instead of registering the keywords for search specified by a user in the cooperation management information table T1 and the contents information table T2, keywords for search can be registered automatically by setting in advance so that the contents of “examination description” of the DICOM data be the keywords for search.

Next, the control unit 11 determines whether each medical information data set is DICOM data or whether patient information and examination information are attached to each medical information data set (step S6).

In a case where a medical information data set is DICOM data or where patient information and examination information are attached to a medical information data set (step S6; YES), the control unit 11 registers the patient information and the examination information included in the DICOM data or the patient information and the examination information attached to the medical information data set with association to the “cooperation management ID” (step S7). In particular, the control unit 11 stores the patient information (“patient ID”, “patient name”, “gender”, “date of birth” and the like) and the “ID of group which sender belongs” in the patient information table T3 with association to each other and stores the “patient ID” included in the patient information in the cooperation management information table T1 with association to the “cooperation management ID”. Moreover, the control unit 11 stores the examination information (“examination UID”, “examination date”, “modality” and the like) and the “ID of group which sender belongs” in the examination information table T4 with association to each other and stores the “examination UID” included in the examination information in the cooperation management information table T1 with associating to the “cooperation management ID”.

Next, in a case where a medical information data set is an image, the control unit 11 registers the image UID with association to the examination UID (step S8). In particular, the control unit 11 adds a new record to the image information table T5 and stores the “examination UID” and the “ID of group which sender belongs” in the image information table T5 by making them associated with the “image UID” corresponding to the medical information data set. Further, the control unit 11 stores the “image UID” in the contents information table T2 with association to the “contents management ID”.

Next, the control unit 11 associates the “contents management ID” with the patient information and the examination information (step S9). In particular, the control unit 11 stores the “patient ID” included in the patient information and the “examination UID” included in the examination information in the contents information table T2 with association to the “content management ID”.

After step S9 or in a case where it is determined that the medical information data set is not DICOM data and patient information and examination information are not attached to the medical information data set in step S6 (step S6; NO), the control unit 11 determines whether the process is done for all of the medical information data sets (step S10). If there is a medical information data set which is not processed yet (step S10; NO), the process returns to step S6 and the process is repeated.

If it is determined that all of the medical information data sets are processed in step S10 (step S10; YES), the new registration process ends.

The user who is the sender can set the viewing right with respect to the user(s) who (are) the receiver when sending a medical information data set. When a user who is the receiver is to be permitted to view, the relevant “viewing right flag” is to be “ON” in the viewing right information table T7, and information indicating that the “open for viewing range” is to be “1”, “3”, “4” or “5” in the cooperation management information table T1 is sent to the data management server 1 from the terminal device 3A. The user who is the sender can change this viewing right.

Moreover, the user who is the sender can et the viewing right with respect to the user(s) belonging to the same group as the user who is the sender when sending a medical information data set. When user belonging to the same group as the user who is the sender is to be permitted to view, the relevant “viewing right flag” is to be “ON” in the viewing right information table T7, and information indicating that the “open for viewing range” is to be “1”, “2”, “4” or “5” in the cooperation management information table T1 is sent to the data management server 1 from the terminal device 3A. The user who is the sender can change this viewing right.

Moreover, the user who is the sender may set the viewing right with respect to a user belonging to the same group as the user who is the sender when sending a medical information data set.

Further, the user who is the sender can set the updating right with respect to the user(s) who is(are) the receiver when sending a medical information data set. When a user who is the receiver is to be permitted to update, information indicating that the relevant “updating right flag” is to be “2” or “3” in the viewing right information table T7 is sent to the data management server 1 from the terminal device 3A. The user who is the sender can change this updating right.

Furthermore, the user who is the sender may be able to set the updating right with respect to a user belonging to the same group as the user who s the sender or with respect to a user belonging to the same group as the user who is the receiver.

The same applies to the deletion right.

### [Cooperation Management ID Issuing Process]

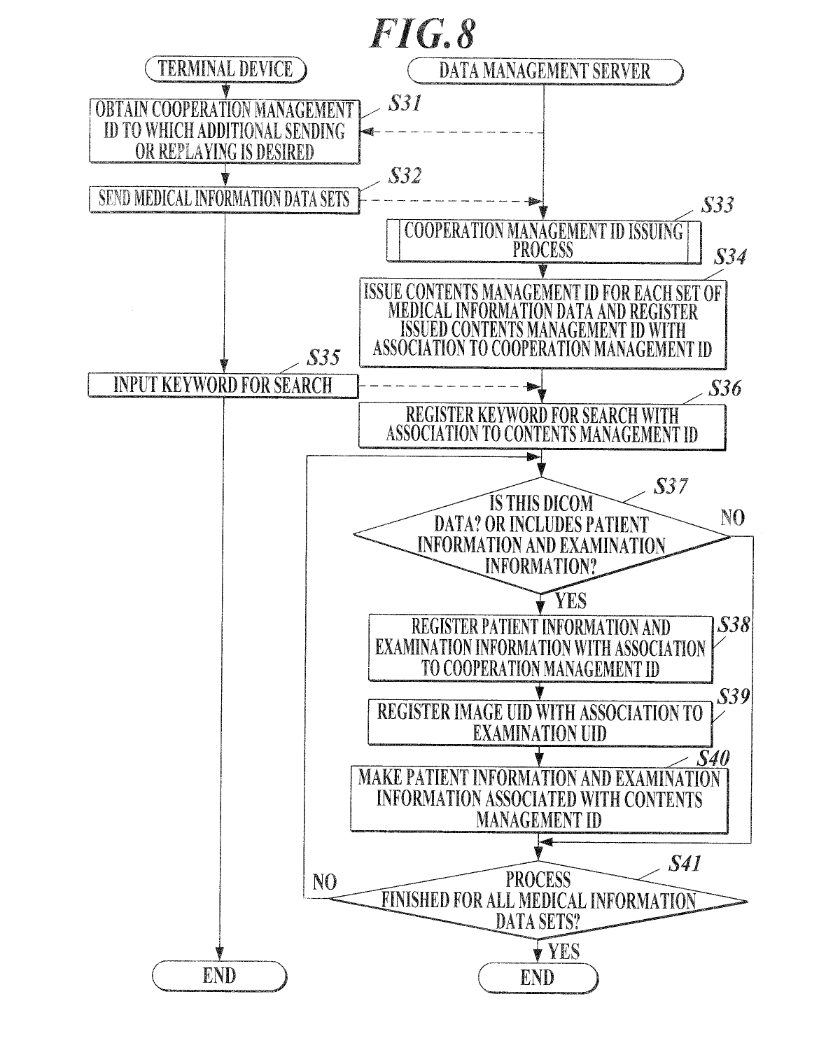

FIGS. 6 and 7 are flowcharts showing the cooperation management. ID issuing process (step S2 in FIG. 5, later described step S33 in FIG. 8) carried out in the data management server 1. The cooperation management ID issuing process is executed by the cooperation between the control unit 11 and the server program P1.

The control unit 11 determines whether the medical information data sets received from the terminal device 3A are newly sent data sets (step S11). In particular, if the medical information data sets are additional sending or replying, the control unit 11 determines that the medical information data sets are not newly sent.

Here, additional sending means that an additional medical information data set is sent to the data management server 1 from the terminal device at the first medical facility so as to be viewed in the terminal device at the second medical facility among the two arbitrary medical facilities in the cooperative medical system 100 in a state where a medical information data set is already sent to the data management server 1 so as to be viewed in the terminal device at the second medical facility from the terminal device at the first medical facility, the additional medical information data set relating to the already sent medical information data set.

Replying means that a medical information data set which is the reply is sent from the terminal device at the second medical facility so as to be viewed in the terminal device at the first medical facility among the two arbitrary medical facilities in the cooperative medical system 100 in a state where a medical information data set is already sent to the data management server 1 from the terminal device at the first medical facility so as to be viewed in the terminal device at the second medical facility, the reply medical information data set relating to the already sent medical information data set.

If a medical information data sets are newly sent (step S11; YES), the control unit 11 decides the management unit of the cooperation management ID manually or through setting (step S12).

In particular, in the terminal device 3A, the medical information data sets to be managed as a group is specified (manually) or the management unit of the cooperation management IDs is selected (setting) by performing an operation on the operating unit 34, and the control unit 31 sends information indicating the management unit of the cooperation management IDs to the data management server 1 via the communication unit 33. For example, a pull-down menu is disposed on the screen displayed in the display unit 35 of the terminal device 3A and any one of “sending by patient”, “sending by examination”, “sending by image”, “collectively sending” is selected. If “sending by patient” is selected, a cooperation managements ID is to be issued for each patient unit. If “sending by examination” is selected, a cooperation management ID is to be issued for each examination unit. If “sending by image” is selected, a cooperation management ID is to be issued for each image unit. If “collectively sending” is selected, the same cooperation management ID is to be issued to the medical information data sets which are sent in one group.

When it is determined that the medical information data sets are not newly sent in step S11 (step S11; NO), that is, when the medical information data sets are additional sending or replying, the control unit 11 decides the management unit of the cooperation management ID in compliance with the previous management unit (step S13). For example, the management unit with respect to the cooperation management ID of the original medical information data set which is the target for additional sending or replying is stored in the storage unit 14, and this management unit is used for the case of additional sending or replying.

After step S12 or step S13, the control unit 11 determines whether DICOM data is included in the received medical information data sets (step S14).

If it is determined that DICOM data is included in the received medical information data sets (step S14; YES), the control unit 11 obtains the information attached to the DICOM data (patient ID, examination UID, image UID and the like) and determines whether a medical information data set of the same management unit as the DICOM data is already stores in the contents storage unit 141 (step S15).

For example, with regard to the past cooperation data, corresponding cooperation management ID, management unit, patient ID, examination UID and image UID (left blank when not available) are managed as a group for each record, and whether the received medical information data sets match any of the past record is determined. When management is to be done in units of examinations, the records will be expressed, for example, as 2f1504fa-7ad3-4d19-8fb9-0334bf78fcd9, STUDY, P-0001, 003457832. The values included in one record respectively represent the cooperation management ID, management unit (examination), patient ID and examination UID. Because the records are in units of examinations, the image UID is omitted. Here, whether the cooperation management ID whose examination UDS is “003457832” exists is searched, and if a relevant cooperation management ID, as the above record, exists, it is determines that the current medical information data set belongs to the cooperation management ID “2f1504fa-7ad3-4d19-8fb9-0334bf78fcd9”.

If it is determined that a medical information data set of the same, management unit as the DICOM data does not exist in the contents storage unit 141 (step S15; NO), the control unit 11 determines whether a plurality of management units exist in the DICOM data (step S16). For example, whether data relating to a plurality of patient exists is determined when the management unit is “patient” and whether data relating to a plurality of examinations exists is determined when the management unit is “examination”.

If it is determined that a plurality of management units exist in the DICOM data (step S16; YES), the control unit 11 issues a cooperation management ID for each management unit with respect to the DICOM data (step S17) For example, when the management unit is “examination”, a cooperation management ID is issued for each examination UID on the basis of the examination UID of the DICOM data.

If it is determined that a plurality of management units do not exist in the DICOM data in step S16 (step S16; NO), the control unit 11 issues one cooperation management ID to the DICOM data (step S18)

When it is determined that a medical information data set of the same management unit as the DICOM data already exists in the contents storage unit 141 (step S15; YES), the control unit 11 applies the cooperation management ID of the already existing medical information data set to the DICOM data (step S19).

After step S17, after step S18, after step S19 or when it is determined, that the received medical information data sets do not include DICOM data in step S14 (step S14; NO), the control unit 11 determines whether data other than DICOM data is included in the received medical information data sets (step S20).

If it is determined that data other than DICOM data is included in the received medical information data sets (step S20; YES), the control unit 11 determines whether information that can be discriminated in management units (units of patient, units of examinations, units of medical treatments and the like) exists in the received medical information data set (step S21).

For example, if letter strings such as “patient ID:*****”, “examination UID: XXXXX” and the like are embedded in a part of Exif information included in a JPEG file, the control unit 11 determines that the JPEG file is data elating to patient ID of “*****”, data relating to examination DID of “XXXXX” or the like.

As for what defines “units of medial treatment”, a user can select, the definition arbitrarily. For example, when a user manually inputs a number which distinguishes each medical treatment (hypothetically called a medical treatment number), and when this medical treatment number is stored as a text file of a specific file name (for example, “medical treatment number.txt”), the control unit 11 determines the medical treatment number from this file.

Further, if a PDF file of a specific format is attached and a letter string such as “medical treatment number: 0123456789” exists at a specific location, the control unit 11 determines that the data has medical treatment number “0123456789”.

Furthermore, if a barcode or a QR code (registered trademark) is embedded in an image file of a specific file name (for example, “medical treatment number.jpeg”) and the code becomes numbers when scanned, the control unit 11 determines that numbers as the medical treatment number.

Moreover, if a letter string such as “medical treatment number: ◯◯◯◯◯” exists only at one location as a result of scanning a sheet in a specific format and performing OCR thereto, the control unit 11 determines the number portion of the result as the medical treatment number.

When it is determined that information that can be discriminated in management units does not exist in step S21 (step S21; NO), the control unit 11 manually sorts out the medical information data in management units (step S22).

In particular, the medical information data sets are sorted out in management units by operations performed on the operating unit 34 in the terminal device 3A and the like and the control unit 31 sends the sorting information indicating how medical information data sets are to be sorted out to the data management server 1 via the communication unit 33.

In the data management server 1, the communication unit 13 receives the sorting information and the control unit 11 sorts out the medical information data sets in management units on the basis of the sorting information.

If it is determined that information that can be distinguished into management units exists in step S21 (step S21; YES) or after step S22, the control unit 11 determines whether a medical information data set of the same management unit as the data other than DICOM data already exists in the contents storage unit 141 (step S23).

If it is determined that a medical information data set of the same management unit as the data other than DICOM data does not already exist in the contents storage unit 141 (step S23; NO), the control unit 11 determines whether a plurality of management units exit in the data other than DICOM data (step S24).

If it is determined that a plurality of management units exist in the data other than DICOM data (step S24, YES), the control unit 11 issues a cooperation management ID for each management unit with respect to the data other than DICOM data (step S25).

If it is determined that a plurality of management units do not exist in the data other than DICOM data in step S24 (step S24; NO), the control unit 11 issues one cooperation management ID with respect to the data other than DICOM data (step S26).

If it is determined that a medical information data set of the same management unit as the data other than DICOM data already exists in the contents storage unit 141 in step S23 (step S23; YES), the control unit 11 applies the cooperation management ID same as that of the already exist medical information data set to the data other than DICOM data (step S27).

After step S25, after step S26, after step S27 or when it is determined that data other than DICOM data is not included in the received medical information data set in step S20 (step S20; NO), the cooperation management ID issuing process ends.

In a case where a medical information data set is DICOM data, if data that can be distinguished in units of medical treatments or in units of examinations is attached to the DICOM data, such as a case where patient information and examination information are attached to a medical information data set, a cooperation management ID is to be issued for each management unit according to the attached data.

If data that can be distinguished in units of medical treatments and in units of examinations is not attached to a medical information data set, a same cooperation management ID is to be issued to the medical information data sets included in the group specified by a user.

Here, a case where the management unit is “examination” and an image relating to the examination C-1 of the patient C is to be newly sent will be discussed. Here, the keyword for search in the cooperation management information table T1 is set to “CT examination” and the keyword for search in the contents information table T2 is set to “lung window”.

In such case, for example, the cooperation management ID: 0001 and the contents management ID: D-001 are issued. Then, the keyword for search which is associated with the cooperation management ID: 0001 is to “CT examination” in the cooperation management information table T1 and the keyword for search which is associated with the contents management ID: D-001 is set to “lung window” in the contents information table T2”.

When an additional image relating to the examination C-1 of the patient C and the past examination C-2 are to be sent additionally, the keyword for searching an additional image relating to the examination C-1 is set to “mediastinal window” and the keyword for searching the examination C-2 is set to “MR examination”.

In such case, because the cooperation management ID: 0001, already exists, only the content management ID: D-002 is issued to the additional image relating to the examination C-1 and the keyword for search is set to “mediastinal window”, That is, the contents management ID: D-002 is made to be associated with the cooperation management ID: 0001 in the contents information table T2, and the keyword for search is set to “mediastinal window”.

Because the examination C-2 is independent from the examination C-1, whether the cooperation management ID relating to the examination C-2 exists is to be confirmed. Then, because the cooperation management ID relating to the examination C-2 does not exist, the cooperation management ID: 0002 is to be issued, for example. The keyword for search which is to be associated with the cooperation management ID: 0002 is set to “MR examination” in the cooperation management information table T1.

### [Additional Sending or Replying Process]

FIG. 8 is a ladder chart showing the additional sending or replying process performed by the terminal device 3A and the data management server 1. Here, the operation in the data management server 1 is executed by the control unit 11 and the server program P1 cooperating with each other, and the operation in the terminal device 3A is executed by the control unit 31 and the application program P2 cooperating with each other.

First, the terminal device 3A, the control unit 31 obtains the cooperation management ID which is the target for additional sending or replying from the data management server 1 via the communication unit 33 (step S31). In particular, the cooperation management ID is obtained by searching based on patient information and examination information or by pre-storing the cooperation management ID at the time of new registration.

Next, according to the operation performed on the operating unit 34, the control unit 31 sends one or a plurality of medical information data sets to the data management server 1 via the communication unit 33, the medical information data sets respectively being associated with the obtained cooperation management ID (step S32).

At this time, the ID of group which sender belongs, the sender user ID, the ID of group which receiver belongs, the receiver user ID and the sent date and time of each medical information data set are also sent to the data management server 1 from the terminal device 3A.

In the data management server 1, the communication unit 13 receives the medical information data sets and the like sent from the terminal device 3A and the control unit 11 carries out the cooperation management ID issuing process (see FIGS. 6 and 7) (step S33).

In the cooperation management ID issuing process, the control unit 11 carries out the process similar to the process carried out at the time of new registration when a cooperation management ID is newly issued.

On the other hand, in a case of applying the existing cooperation management ID, first, the control unit 11 adds a new record to the cooperation history information table T6 in the storage unit 14 for each medical information data set. In particular, the control unit 11 assigns a new “cooperation history ID” and stores the “cooperation management ID”, “ID of group which sender belongs”, “sender user ID”, “ID of group which receiver belongs”, “receiver user ID” and “sent date and time” which are received from the terminal device 3A in the cooperation history information table T6 by making them associated with the new “cooperation history ID”.

Further, from the cooperator information table T8, the control unit 11 obtains the “cooperator information ID” which is associated with the combination of the “ID of group which cooperation requester belongs”, “cooperation requester user ID”, “ID of group which cooperator belongs” and “cooperator user ID” corresponding to the combination of the “ID of group which sender belongs”, “sender user ID”, “ID of group which receiver belongs” and “receiver user ID” which are received from the terminal device 3A. The control, unit 11 obtains the “viewing right ID” which is associated with the “cooperator information ID” obtained from the cooperator information table T8 from the viewing right information table T7, and the control unit 11 adds this “viewing right ID” in the cooperation history information table T6 in the storage unit 14 with association to the “cooperation history ID”.

Next, the control unit 11 stores each medical information data set in the content storage unit 141, issues a “contents management ID” to each medical information data set and registers the “contents management ID” with association to the “cooperation management ID” (step S34. In particular, the control unit 11 adds a new record to the contents information table T2 for each medical information data set. Then, the control unit 11 newly issues a “contents management ID” for each medical image data set and stores the “cooperation management ID”, “content file path” and “content type” in the contents information table T2 by making them associated with this “contents management ID”. Here, the “deletion flag” of each new record is set to “OFF” in the contents information table T2.

Next, in the terminal device 3A, keywords for search are input by the operating unit 34 and the control unit 31 sends the keywords for search to the data management server 1 via the communication unit 33 (step S35).

When a new cooperation management ID is issued in step S33, similarly to the case of new registration, the open for viewing range and the open for viewing period are input by the operating unit 34 in the terminal device 3A and they are sent to the data management server 1.

In the data management server 1, the communication unit 13 receives the keywords f or search which are sent from the terminal device 3A and the control unit 11 registers the “keyword for search” in the contents information table T2 with association to the “contents management ID” (step S36).

Here, when a new cooperation management ID is issued in step S33, similarly to the case of new registration, the “open for viewing range” and the “open for viewing period” are also registered with association to the “cooperation management ID” and the “contents management ID”.

The process of steps S37 to S41 is similar to the process of steps S6 to S10 in FIG. 5. Therefore, the description is omitted.

With the above description, the additional sending or replying process ends.

Here, in a case where the cooperation management ID is pre-held by the sender and data sets with no information associated with patient information and examination information are to be sent, the data sets may be managed as one group of cooperation data by sending the data sets with association to the pre-held cooperation management ID.

### [Deletion Process]

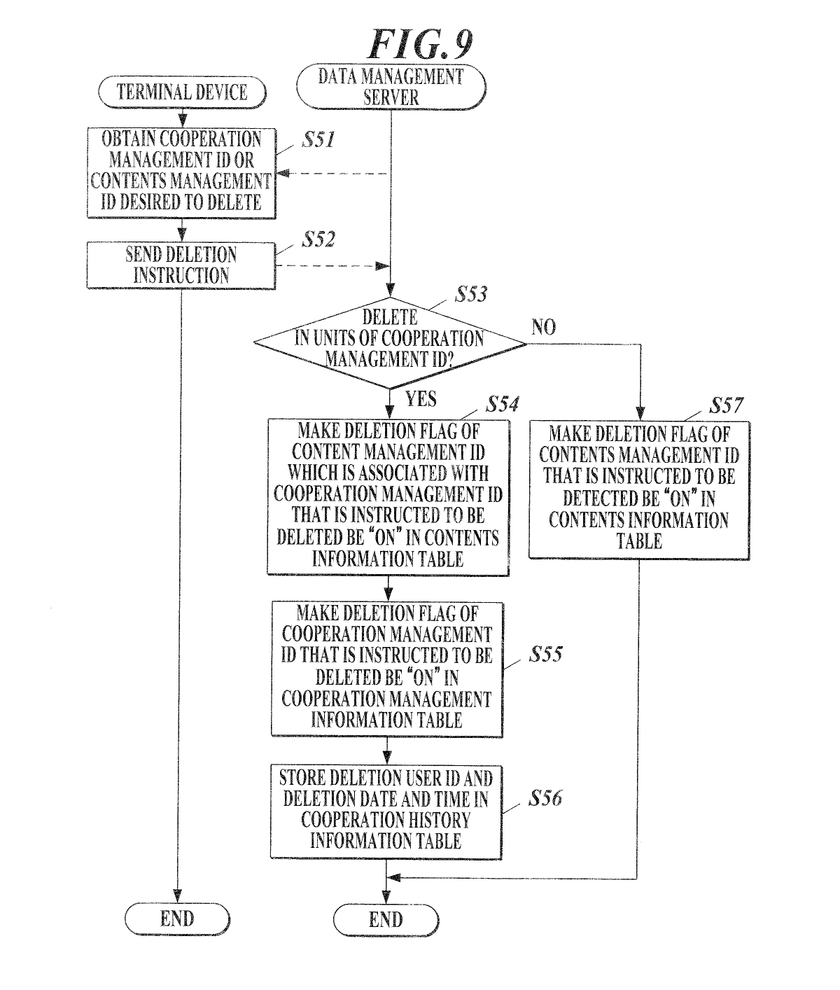

FIG. 9 is a ladder chart showing the deletion process carried out by the terminal device 3A and the data management server 1. Here, the operation in the data management server 1 is executed by the control unit 11 and the server program P1 cooperating with each other, and the operation in the terminal device 3A is executed by the control unit 31 and the application program P2 cooperating with each other.

First, in the terminal device 3A, the control unit 31 obtains the cooperation management ID or the contents management ID which is the target for deletion from the data management server 1 via the communication unit 33 (step S51). In particular, the cooperation management ID or the contents management ID is obtained by searching based on patient information and examination information or by pre-storing the cooperation management ID or the contents management ID at the time of new registration.

Next, on the basis of the operation performed on the operating unit 34, the control unit 31 sends the deletion instruction along with the cooperation management ID or the contents management ID targeted for deletion to the data management server 1 via the communication unit 33 (step S52).

In the data management server 1, the communication unit 13 receives the cooperation management ID or the contents management ID which is the target for deletion and the deletion instruction which are sent from the terminal device 3A.

Next, the control unit 11 determines whether deletion is to be performed in units of cooperation management. ID according to whether the cooperation management ID is received from the terminal device 3A along with the deletion instruction or whether the contents management ID is received from the terminal device 3A along with the deletion instruction (step S53).

In a case where deletion is to be performed in units of cooperation management ID (step S53; YES), the control unit 11 changes the “deletion flag” of each “contents management ID” associated with the “cooperation management ID” which is instructed to be deleted to “ON” in the contents information table T2 (step S54).

Next, the control unit 11 changes each “deletion flag” associated with the “cooperation management ID” which is instructed to be deleted to “ON” in the cooperation management information table T1 (step S55)

Next, the control unit 11 stores the user ID of the user of the terminal device 3A for each “deletion user ID” associated with the “cooperation management ID” which is instructed to be deleted in the cooperation history information table T6 and stores the date and time when the “deletion flag” was changed to “ON” in step S55 for each “deletion date and time” in the cooperation history information table T6 (step S56).

If it is determined that deletion is not, to be performed in units of cooperation management ID in step S53 (step S53; NO), the control unit 11 changes the “deletion flag” of each “contents management ID” which is instructed to be deleted to “ON” in the contents information table T2 (step S57).

After step S56 or step S57, the control unit 11 ends the deletion process.

The sender user has the right to delete in units of cooperation management ID with respect the medical information data sets sent by the sender user himself/herself and the medical information data sets replied by the cooperator. Whether the receiver user, the users belonging to the same group as the sender user or the users belonging to the same group as the receiver user are given the right to delete is decided by the sender user when sending the medical information data sets and this may be further changed after the sending.

The users who have the right to delete in units of cooperation management ID can delete the medical information data sets in management units or in units of contents.

### [Can/Cannot Be Viewed Determination Process]

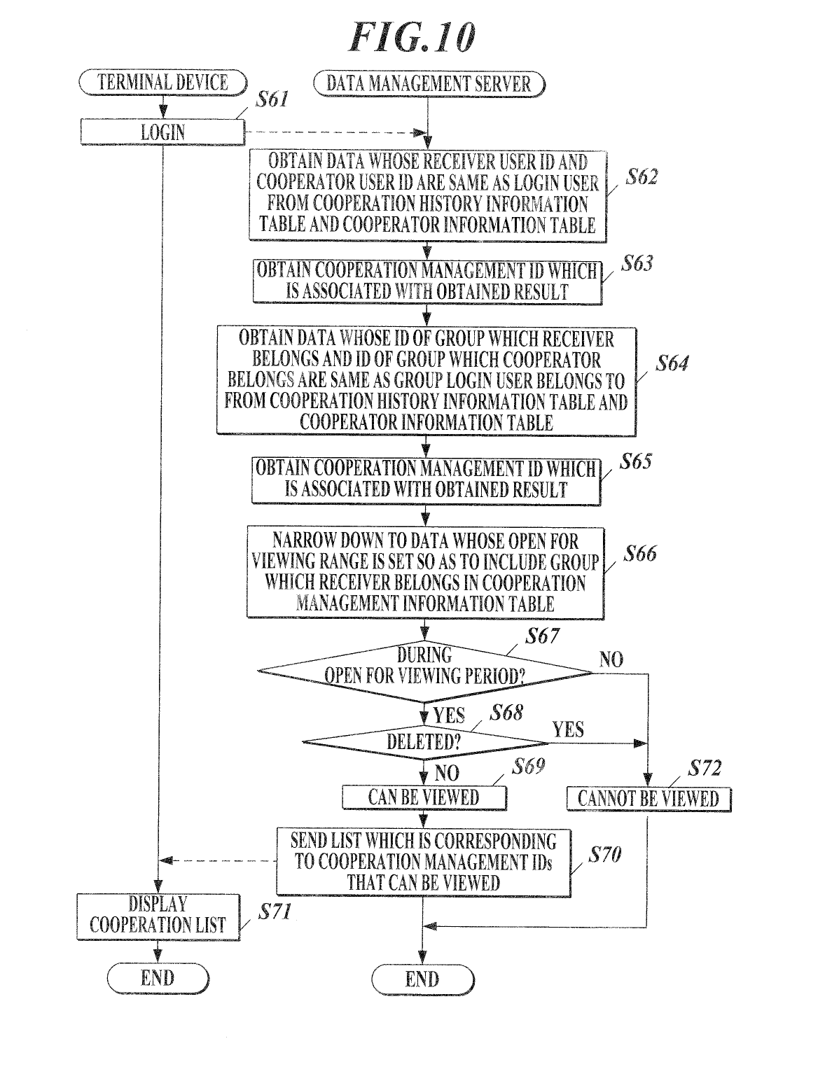

FIG. 10 is a ladder chart showing the can/cannot be viewed determination process performed by the terminal device 3A and the data management server 1. In this process, when a user assesses the data management server 1, a list of cooperation management IDs which the users has viewing right (hereinafter called a cooperation list) is displayed. Here, the operation in the data management server 1 is executed by the control unit 11 and the server program P1 cooperating with each other, and the operation in the terminal device 3A is executed by the control unit 31 and the application program P2 cooperating with each other.

First, in the terminal device 3A, the control unit 31 logs in to the cooperative medical system 100 on the bases of the operation performed on the operating unit 34 (step S61). For example, the control unit 31 sends the user ID and the password to the data management server 1 via the communication unit 33, and the login is completed when the user is confirmed as being the user registered in the data management server 1.

In the data management server 1, the control unit 11 obtains the data sets whose “receiver user ID” and the “cooperator user ID” are the login user from the cooperation history information table T6 and the cooperator information table T8 (step S62).

In particular, the control unit 11 refers to the cooperation history information table T6 and obtains the “viewing right IDs” of the records whose “receiver user IDs” are the login user.

Next, the control unit 11 refers he viewing right information table T7 and obtains the “cooperator information IDs” associated with the obtained “viewing right IDs”. If the “viewing right flag” is “OFF” in the viewing right information table T7, the corresponding record is determined as invalid and the data set associated with the corresponding “viewing right ID” is eliminated from the candidates to be viewed.

Next, the control unit 11 refers to the cooperator information table T8 and allows only the data sets whose “cooperator user IDs” associated with the obtained “cooperator information IDs” are the login user to remain as the candidates to be viewed. Here, if the “deletion flag” is “ON” in the cooperator information table T8, the corresponding record is determined as invalid and the data set associated with the corresponding “cooperator information ID” is eliminated from the candidates to be viewed.

Next, the control unit 11 obtains the “cooperation management IDs” associated with the obtaining results (step S63).

In particular, the control unit 11 obtains the “cooperation management IDs” associated with the “viewing right IDs” which are determined to be valid in the viewing right information table T7 and the cooperator information table T8 in the “viewing right IDs” of the records whose “receiver user ID” obtained from the cooperation history information table T6 are the login user.

Next, the control unit 11 obtains e data sets whose “ID of group which receiver belong” and “ID of group which cooperator belong” in the cooperation hi story information table T6 and the cooperator information table T8 are the group which the login user belongs to (step S64)

In particular, the control unit 11 refers to the cooperation history information table T6 and obtains the “viewing right IDs” of the records whose “ID of group which receiver belongs” are the same as the group which the login user belongs to.

Next, the control unit 11 refers to the viewing right information table T7 and obtains the “cooperator information IDs” associated with the obtained “viewing right IDs”. If the “viewing right flag” is “OFF” in the viewing right information table T7, the corresponding record is determined as invalid and the data set associated with the corresponding “viewing right ID” is eliminated from the candidates to be viewed.

Next, the control unit 11 refers to the cooperator information table T8 and allows only the data sets whose “ID of group which cooperator belongs” associated with the obtained “cooperator information IDs” are the same as the group which the login user belongs to as the candidates that can be viewed. If the “deletion flag” is “ON” in the cooperator information table T8, the corresponding record is determined as invalid and the data associated with the corresponding “cooperator information ID” is eliminated from the candidates to be viewed.

Next, the control unit 11 obtains the “cooperation management IDs” associated with the obtaining results (step S65).

In particular, the control unit 11 obtains the “cooperation management IDs” associated with the “viewing right IDs” which were determined as valid in the viewing right. information T7 and the cooperator information table T8 in the “viewing right IDs” of the records whose “ID of group which receiver belongs” obtained from the cooperation history information table T6 are the same as the group which the login user belongs to.

Next, the control unit 11 narrows down the “cooperation management IDs” obtained in step S65 to those whose “open for viewing range” in the cooperation management information table T1 are set to “including groups which receiver belongs” (step S66).

Next, the control unit 11 refers to the “open for viewing period” in the cooperation management information table T1 and determines whether the “cooperation management IDs” obtained in steps S63 and S66 are during the open for viewing period (step S67).

If the control unit 11 determines that the medical information data sets managed by the “cooperation management IDs” obtained in steps S63 and S66 are during the open for viewing period (step S67; YES), the control unit 11 refers to the “deletion flags” in the cooperation management information table T1 and determines whether the records associated with the relevant “cooperation management IDs” are deleted (step S68).

If the control unit 11 determines that the records associated with the relevant “cooperation management IDs” are not deleted (step S68; NO), the control unit 11 determines that the records can be viewed (step S69) and sends the list corresponding to the “cooperation management IDs” which can be viewed to the terminal device 3A via the communication unit 13 (step S70).

In the terminal device 3A, the communication unit 33 receives the list corresponding to the “cooperation management IDs” which can be viewed and the control unit 31 displays the cooperation list in the display unit 35 (step S71).

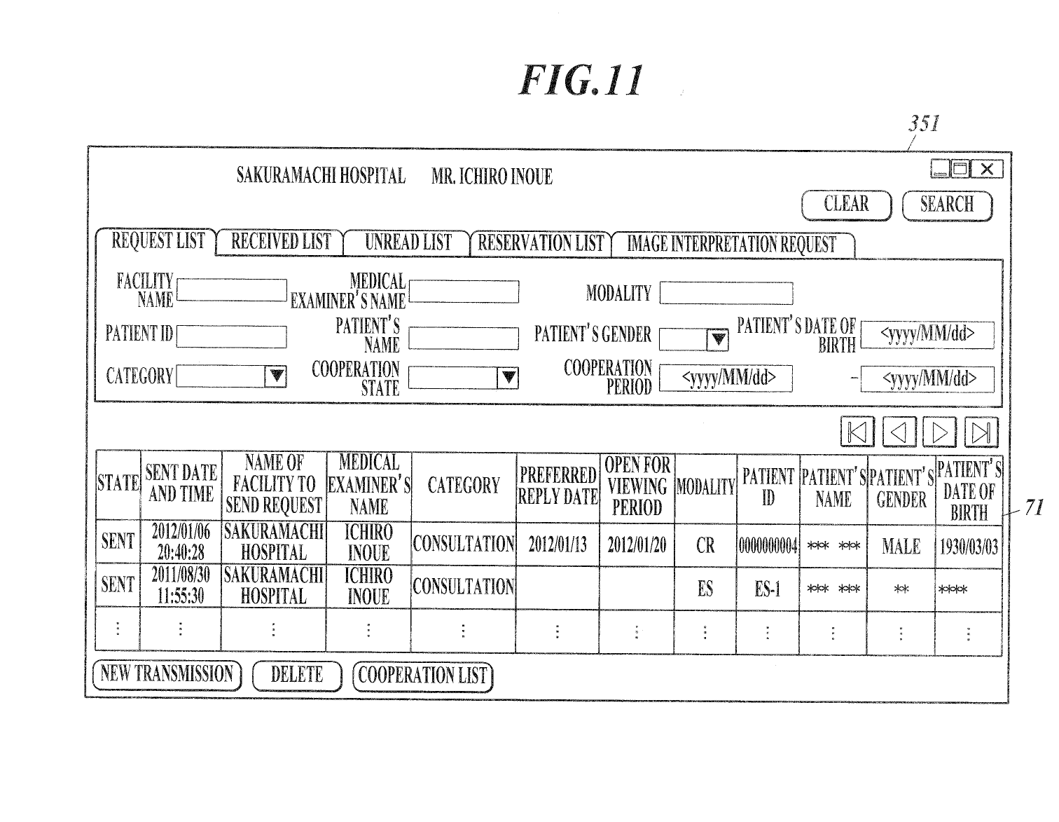

FIG. 11 shows an example of the cooperation list screen 351 to be displayed in the display unit 35 of the terminal device 3A. In the cooperation list display region 71 of the cooperation list screen 351, a list is to be displayed in management units corresponding to the “cooperation management IDs” which can be viewed, By selecting from this cooperation list, a medical information data set associated with the “cooperation management ID” and the “content management ID” can be obtained.

If the control unit 11 determines that the medical information data sets managed by the “cooperation management IDs” obtained in steps S63 and S66 are not during the open for viewing period in step S67 (step S67; NO) or if the control unit 11 determines that the records associated with the relevant “cooperation management IDs” are deleted in step S68 (step S68; YES), the control unit 11 determines that the records cannot be viewed (step S72).

With the above description, the can/cannot be viewed determination process ends.

### [Search Process]

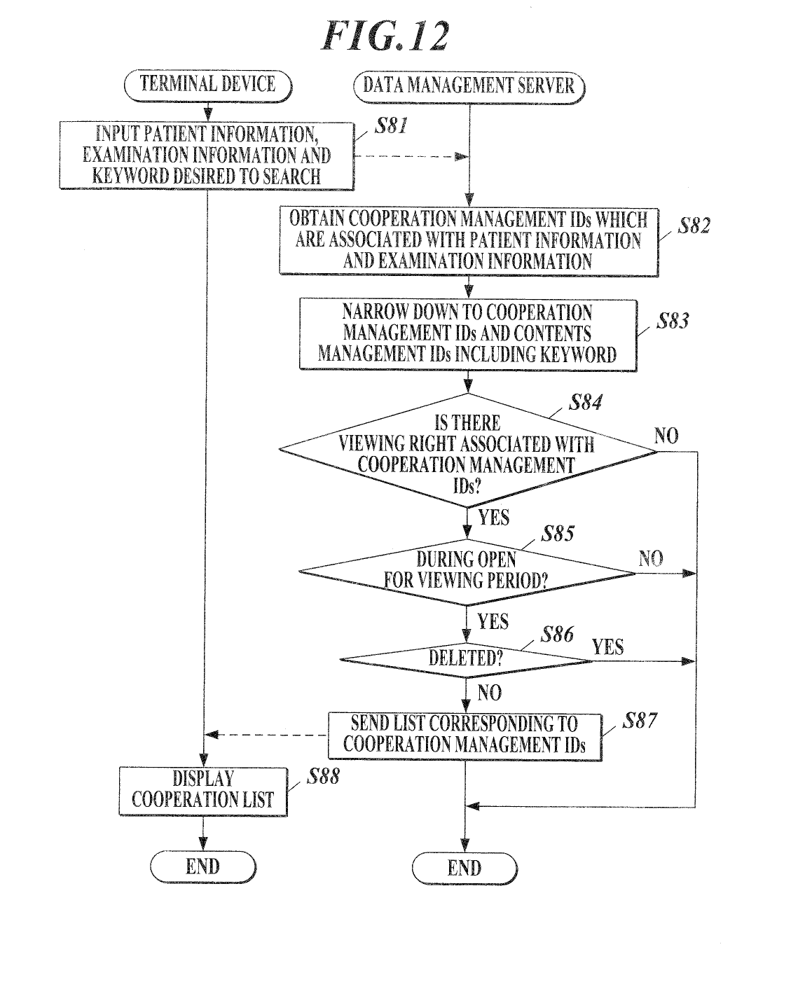

FIG. 12 is a ladder chart showing the search process performed by the terminal device 3A and the data management server 1. Here, the operation in the data management server 1 is executed by the control unit 11 and the server program P1 cooperating with each other, and the operation in the terminal device 3A is executed by the control unit 31 and the application program P2 cooperating with each other.

First, in the terminal device 3A, the patient information, examination information and a keyword with which a user desires to carry out search are input by the operating unit 34 and the control unit 31 sends the patient information, examination information and a keyword to the data management server 1 via the communication unit 33 (step S81). Here, input of a keyword can be arbitrary.

In the data management server 1, the communication unit 13 receives the patient information, examination information and a keyword which are sent from the terminal device 3A. Then, the control unit 11 obtains the “communication management IDs” associated with the patient information and the examination information (step S82).

In particular, the control unit 11 refers the patient information table T3 and the examination information table T4 and obtains “patient IDs” and “examination IDs” (when patient information is “patient ID” and when examination information is “examination UID”, obtains the “patient ID” and the “examination ID” per se) associated with the patient information (“patient ID”, “patient name”, “gender”, “date of birth” and the like) and the examination information (“examination UID”, “examination date”, “modality” and the like) obtained from the terminal device 3A. Then, the control unit 11 refers to the cooperation management information table T1 and obtains the “cooperation management IDs” associated with the obtained “patient ID” and “examination ID”.

Next, with respect to the obtained “cooperation management IDs”, the control unit 11 refers to the cooperation management information table T1 and the contents information table T2 and narrows down to “cooperation management IDs” and “contents management IDs” associated with the keyword received from the terminal device 3A (step S83).

Next, the control unit 11 determines whether the user of the terminal device 3A has the viewing right associated with the “cooperation management IDs” narrowed down in step S83 (step s84).

In particular, the control unit 11 refers to the cooperation management information table T1, obtains the “open for viewing range” associated with the “cooperation management IDs” and determines whether the user who is performing the search operation at the terminal device 3A is included in the “open for viewing range”.

Further, the control unit 11 refers to the viewing right information table T7 and determines whether the “viewing right flags” relevant to the “viewing right IDs” corresponding to the “cooperation management IDs” are set to “ON”.

Furthermore, the control unit 11 refers to the viewing right information table T7 and obtains the “cooperator information IDs” associated with the “viewing right IDs” corresponding to the “cooperation management IDs”. Then, the control unit 11 refers to the cooperator information table T8 and obtains the “cooperator user ID”, “ID of group which cooperator belongs”, “cooperation type” and “deletion flag” corresponding to the above obtained “cooperator information IDs”. The control unit 11 allows the data sets whose “cooperator user IDs” are the search user, whose “ID of group which cooperator belongs” are same as the group the search user belongs and whose “cooperation type” includes the search user as their receiver remain as the candidate for searching. Further, the control unit 11 determines that the record is invalid if the “deletion flag” if set to “ON” in the cooperator information table T8”, and the control unit 11 eliminates the data sets associated with the corresponding “cooperator information IDs” from the candidates for searching.

Here, if the “cooperator user ID” associated with the “cooperator information ID” is the same as the user ID of the search user in the cooperator information table T8, the corresponding data set is subject to searching with no condition.

If it is determined that the user of the terminal device 3A has the viewing right associated with the “cooperation management IDs” narrowed down in step S83 in step S84 (step S84; YES), the control unit 11 refers to the “open for viewing period” in the cooperation management information table T1 and determines whether the “cooperation management IDs” are during their open for viewing period (step S85).

If it is determined that the “cooperation management IDs” are in their open for viewing period (step S85; YES), the control unit 11 refers to the “deletion flag” in the cooperation management information table T1 and determines whether the records associated with the relevant “cooperation management IDs” are deleted (step S86).

If it is determined that the records associated with the relevant “cooperation management IDs” are not deleted (step S86; NO), the control unit 11 sends the list corresponding to the relevant “cooperation management IDs” to the terminal device 3A via the communication unit 13 (step S87).

In the terminal device 3A, the communication unit 33 receives the list corresponding to the “cooperation management IDs” of searching results and the control unit 31 displays the cooperation list in the display unit 35 (step S88).

If it is determined that the user of the terminal device 3A does not have the viewing right associated with the “cooperation management IDs” narrowed down in step S83 in step S84 (step S84; NO), if it is determined that the “cooperation management IDs” are not during their open for viewing period (step S85; NO) or if it is determined that the records associated with the relevant “cooperation management IDs” are deleted in step S86 (step S86; YES), the control unit 11 ends the search process.

The cooperation data which is managed in the data management server 1 can be searched by using the tables to which medical information data sets and keyword for search are associated thereto.

Among the patient information and the examination information attached to a medical information data set, by making the frequently used items (for example, patient ID, patient name, gender, date of birth, name of facility who is cooperator, cooperator user name, sent date and time and the like) associated with the cooperation management ID and the content management ID, search can be performed faster.

The interactions between the terminal device 3A and the data management server 1 are mainly described in the above. However, the similar interactions are performed between the other terminal device 3B and the like and the data management server 1.

As described above, according to the cooperative medical 100, medical information data sets are managed in arbitrary management units (cooperation management ID) according to a user's preference, the arbitrary management unit being patient unit, examination unit, image unit, medical treatment unit, series unit or the like, for example. Therefore, medical information data sets can be managed efficiently.

Moreover, not only DICOM data but also multimedia data such as Word, Excel, PDF, PNG, video and the like can be managed with associated to the cooperation management IDs

Further, the viewing right of medical information data sets can be set in units of cooperation management IDs.

Furthermore, by making patient information, examination information, keywords and the like associated with each other in units of cooperation management IDs, medical information data sets can be searched on the basis of the patient information, examination information, keyword and the like.

The above described embodiment is an example of the medical information data management system according to the present invention, and the present invention is not limited to the above embodiment. The detail configurations and detail operations of the devices constituting the system can be modified arbitrary within the scope of the present invention.

For example, in the above embodiment, the case where the cooperation management IDs are issued in the data management server 1 is described. However, the cooperation management IDs can be issued in the terminal devices 3A, 3B . . . which are the senders. Here, the cooperation management IDs must be decided uniquely in the system. For example, UUID (Universally Unique Identifier) format or the like is used for the cooperation management IDs.

In the above description, an example where HDD and non-volatile memory are used as a computer readable medium in which programs for executing the processes is described. However, the present invention is not limited to such example. A portable storage medium such as a CD-ROM can be used as other computer readable medium. Further, carrier wave can be used as a medium which provides program data through a communication circuit.

The entire disclosure of Japanese Patent Application No. 2012-126651 filed on Jun. 4, 2012 is incorporated herein by reference.

What is claimed is:

1. A medical information data management system for managing a plurality of medical information data sets generated at a plurality of medical facilities, comprising:
a specifying unit, which specifies arbitrary management units, each of which including one or a plurality of medical information data sets, with respect to the plurality of medical information data sets;
an ID issuing unit which issues cooperation management IDs respectively to the specified management units; and
a storage unit which stores the issued cooperation management IDs and the medical information data sets, each cooperation management ID being associated with medical information data sets that belong to a management unit corresponding to the cooperation management ID.

2. The medical information data management system claim 1 further comprising:
a second storage unit which stores the cooperation management IDs and viewing right information indicating viewing rights of the medical information data sets, each cooperation management ID being associated with viewing right information indicating viewing rights of medical information data sets that belong to a management unit corresponding to the cooperation management ID; and
a permission unit which permits viewing of the medical information data sets stored in the storage unit in management units on a basis of the viewing right information stored in the second storage unit.

3. The medical information data management system of claim 1 further comprising:
a third storage unit which stores the cooperation management IDs and patient information, examination information or keywords relating to the medical information data sets, each cooperation management ID being associated, with patient information, examination, information or a keyword relating to medical information data sets that being to a management unit corresponding to the cooperation management ID; and
a search unit which searches for medical information data sets stored in the storage unit in management units on a basis of the patient information, the examination information or the keywords stored in the third storage unit.
